(19) United States
(12) Patent Application Publication
(10) Pub. No.: US 2013/0014787 A1
(43) Pub. Date: Jan. 17, 2013

(54) SUBSTRATE PROCESSING APPARATUS AND SUBSTRATE PROCESSING METHOD

(71) Applicants: Shingo URATA, Kyoto-shi (JP); Akihiko TAKI, Kyoto-shi (JP); Hiroki TSUJIKAWA, Kyoto-shi (JP); Eri FUJITA, Kyoto-shi (JP); Yoshiyuki FUJITANI, Kyoto-shi (JP)

(72) Inventors: Shingo URATA, Kyoto-shi (JP); Akihiko TAKI, Kyoto-shi (JP); Hiroki TSUJIKAWA, Kyoto-shi (JP); Eri FUJITA, Kyoto-shi (JP); Yoshiyuki FUJITANI, Kyoto-shi (JP)

(21) Appl. No.: 13/544,207

(22) Filed: Jul. 9, 2012

(30) Foreign Application Priority Data
Jul. 12, 2011 (JP) 2011-154020

(51) Int. Cl. B08B 3/00

(52) U.S. Cl. 134/100.1; 134/18

(57) ABSTRACT

A substrate processing apparatus supplies a resist stripping solution, formed by mixing sulfuric acid and a hydrogen peroxide solution, to a surface of a substrate. The substrate processing apparatus includes a nozzle that discharges the resist stripping solution toward the substrate, a hydrogen peroxide solution supply passage through which the hydrogen peroxide solution flows toward the nozzle, a plurality of sulfuric acid supply passages respectively connected to a plurality of mixing positions along the hydrogen peroxide solution supply passage that differ in flow passage length to the nozzle, and a sulfuric acid supply passage selecting unit that introduces the sulfuric acid from a sulfuric acid supply source to a sulfuric acid supply passage selected from among the plurality of sulfuric acid supply passages.

### BACKGROUND OF THE INVENTION

1. Field of the Invention

The present invention relates to a substrate processing apparatus and a substrate processing method for supplying a resist stripping solution, formed by mixing sulfuric acid and a hydrogen peroxide solution, to a surface of substrate. Examples of substrates to be processed include semiconductor wafers, substrates for liquid crystal displays, substrates for plasma displays, substrates for FEDs (Field Emission Displays), substrates for optical disks, substrates for magnetic disks, substrates for magneto-optical disks, substrates for photomasks, ceramic substrates, substrates for solar cells, etc.

2. Description of Related Art

In a manufacturing process for a semiconductor device, etc., a resist pattern is formed on a surface of a substrate for selective etching or selective ion implantation. Thereafter, a resist stripping process of stripping the resist from the substrate is performed. As a resist stripping solution used in a case of performing the resist stripping as a liquid process, for example, a mixed solution of sulfuric acid and a hydrogen peroxide solution (SPM: sulfuric acid/hydrogen peroxide mixture) is used. The SPM exhibits a high resist stripping ability because it contains peroxysulfuric acid (Caro's acid), which has a high oxidizing power, and because its solution temperature rises due to a heat of reaction generated when the sulfuric acid and the hydrogen peroxide solution are mixed.

An example of a substrate processing apparatus that performs a resist stripping process using SPM is disclosed in Japanese Unexamined Patent Application Publication No. 2010-225789. The substrate processing apparatus includes a sulfuric acid supply passage through which sulfuric acid that is raised in temperature is fed toward a nozzle, a hydrogen peroxide solution supply passage connected to each of a plurality of mixing points provided at different positions along the sulfuric acid supply passage, and a control means by which a flow rate of the hydrogen peroxide solution flowing from the hydrogen peroxide solution supply passage into the sulfuric acid supply passage is controlled individually at each of the plurality of mixing points. Passage lengths from the plurality of mixing points to the nozzle differ and thus times from the mixing of the sulfuric acid and hydrogen peroxide solution to the reaching of the nozzle differ. Thus, by appropriately selecting a mixing point, for example, in accordance with the temperature of the sulfuric acid before mixing, a resist stripping solution can be raised in temperature using the temperature rise due to the heat of reaction during mixing, and the resist stripping solution of appropriate temperature can be discharged from the nozzle. Also, by controlling the flow rate of the hydrogen peroxide solution flowing into the sulfuric acid supply passage from the hydrogen peroxide solution supply passage, a mixing ratio of the hydrogen peroxide solution and the sulfuric acid can be adjusted.

When sulfuric acid and hydrogen peroxide solution are mixed, a heat of reaction is generated, and thus the temperature of the mixed solution (SPM) rises once with elapse of time from mixing and then decreases after reaching a peak. Also, a concentration of oxidants (peroxysulfuric acid, etc.) in the SPM decreases with the elapse of time from mixing. The temperature variation and oxidant concentration variation of the SPM after mixing are dependent on the temperature of the sulfuric acid before mixing. A resist stripping performance of the SPM discharged from the nozzle can thus be maximized by optimal selection of the mixing point in accordance with the temperature of the sulfuric acid before mixing.

The mixing ratio of the sulfuric acid and hydrogen peroxide solution for maximizing the resist stripping performance of SPM also depends on the temperature of the sulfuric acid before mixing. The resist stripping solution of maximum performance can thus be discharged from the nozzle by optimizing the mixing ratio in accordance with the temperature of the sulfuric acid before mixing. In this case, if the mixing ratio is adjusted by changing just the flow rate of the hydrogen peroxide solution, insufficiency or excess occurs in the flow rate of the resist stripping solution discharged from the nozzle. Thus, not just the hydrogen peroxide solution flow rate but the flow rate of the sulfuric acid must also be adjusted together.

However, flow controllers capable of automatic control can only accommodate fluids of ordinary temperature. Thus, whereas the adjustment of the hydrogen peroxide solution flow rate can be performed by a flow controller, the adjustment of the sulfuric acid flow rate must be performed by a manually operated needle valve. Thus, even with the arrangement in Japanese Unexamined Patent Application Publication No. 2010-225789, manual adjustment of a needle valve interposed in the sulfuric acid supply passage is necessary for changing the temperature of the sulfuric acid to be used. To be more specific, manual adjustment of the needle valve and evaluation by performing actual discharge of the SPM solution (trial substrate processing) must be performed repeatedly to find an appropriate opening position of the needle valve. Such adjustment requires long hours of work by a skilled worker.

### SUMMARY OF THE INVENTION

A preferred embodiment of the present invention provides a substrate processing apparatus and a substrate processing method by which a change of temperature of sulfuric acid can be accommodated readily.

A preferred embodiment of the present invention provides a substrate processing apparatus that supplies a resist stripping solution, formed by mixing a sulfuric acid and a hydrogen peroxide solution, to a surface of a substrate, the substrate processing apparatus including a nozzle that discharges the resist stripping solution toward the substrate, a hydrogen peroxide solution supply passage through which the hydrogen peroxide solution flows toward the nozzle, a plurality of sulfuric acid supply passages respectively connected to a plurality of mixing positions along the hydrogen peroxide solution supply passage that differ in flow passage length to the nozzle, and a sulfuric acid supply passage selecting unit that introduces the sulfuric acid from a sulfuric acid supply source to a sulfuric acid supply passage selected from among the plurality of sulfuric acid supply passages.

With the present arrangement, the plurality of sulfuric acid supply passages are respectively connected to the plurality of mixing positions along the hydrogen peroxide solution supply passage. The sulfuric acid and hydrogen peroxide solution are thus mixed to form the resist stripping solution made of the mixed solution at any one of the mixing positions. The resist stripping solution rises in temperature due to an exothermic reaction due to the mixing inside the flow passage leading from the point of mixing to the nozzle, and the resist stripping solution that has risen in temperature is discharged toward the substrate from the nozzle. The sulfuric acid supply passage selecting unit selects one or a plurality (preferably one) of sulfuric acid supply passages from among the plurality of sulfuric acid supply passage and introduces the sulfuric acid from the sulfuric acid supply source into each selected sulfuric acid supply passage. A selection of a sulfuric acid supply passage translates to a simultaneous selection of a mixing position. The resist stripping solution is thus discharged from the nozzle after a time, which is in accordance with a flow passage length from the selected mixing position to the nozzle, elapses after the mixing of the sulfuric acid and the hydrogen peroxide solution. During this time, the resist stripping solution rises in temperature due to heat generation by the mixing of the sulfuric acid and the hydrogen peroxide solution. Thus, by selection of the sulfuric acid supply passage, the flow passage length from the point of mixing of the sulfuric acid and the hydrogen peroxide solution to the nozzle can be selected. Also, by setting a flow rate of the sulfuric acid individually for each of the plurality of sulfuric acid supply passage, switching of the sulfuric acid flow rate can be achieved by simply switching the sulfuric acid supply passage and without having to use a flow controller. Adjustment of the sulfuric acid flow rate is thus easy. Thus, if change of the mixing position and change of the sulfuric acid flow rate in accordance with the temperature of sulfuric acid are required, such requirements can be accommodated immediately.

Each of the plurality of sulfuric acid supply passages may be arranged so that the sulfuric acid flows through toward the corresponding mixing position at an individually set flow rate. With this arrangement, the flow rates at the plurality of sulfuric acid supply passages are respectively set individually, and the sulfuric acid flow rate can thus be changed readily by changing the sulfuric acid supply passage.

The flow rates and the corresponding mixing positions of the plurality of sulfuric acid supply passages may be set to correspond to respective sulfuric acids of different temperatures. With this arrangement, the mixing position and the sulfuric acid flow rate are set appropriately at the same time by selection of the sulfuric acid supply passage in accordance with the temperature of sulfuric acid. Accommodation of a change of the sulfuric acid temperature is thereby facilitated further.

Also preferably, the substrate processing apparatus according to the preferred embodiment of the present invention further includes a control unit that controls the sulfuric acid supply passage selecting unit in accordance with a temperature of the sulfuric acid from the sulfuric acid supply source. With this arrangement, the sulfuric acid supply passage selecting unit is controlled by the control unit and thus changes of the mixing position and sulfuric acid flow rate in accordance with the temperature of the sulfuric acid can be automated.

Also preferably, the substrate processing apparatus according to the preferred embodiment of the present invention further includes a plurality of flow regulating valves respectively interposed in the plurality of sulfuric acid supply passages. With this arrangement, the flow rates at the plurality of sulfuric acid supply passages can be respectively set individually by the plurality of flow regulating valves (for example, manually operated flow regulating valves, such as needle valves) respectively interposed in the plurality of sulfuric acid supply passages. For example, opening degrees of the plurality of flow regulating valves may be individually adjusted appropriately so that flow rates that are in accordance with a plurality of different sulfuric acid temperatures can be obtained. Then, when the temperature of the sulfuric acid used is to be changed, the sulfuric acid can be supplied at the flow rate that is in accordance with the temperature simply by switching the selection of the sulfuric acid supply passage.

Also preferably, the substrate processing apparatus according to the preferred embodiment of the present invention further includes a flow controller that controls a flow rate of the hydrogen peroxide solution flowing through the hydrogen peroxide solution supply passage. With this arrangement, the flow rate of the hydrogen peroxide solution is controlled by the flow controller to enable the sulfuric acid and the hydrogen peroxide solution to be mixed at an appropriate mixing ratio and enable the resist stripping solution to be discharged from the nozzle at a required discharge flow rate.

Also preferably, the substrate processing apparatus according to the preferred embodiment of the present invention further includes an agitating unit disposed between a most downstream mixing position and a most upstream mixing position in the hydrogen peroxide solution supply passage and arranged to agitate the mixed solution of the sulfuric acid and the hydrogen peroxide solution. With this arrangement, mixing of the resist stripping solution can be promoted by the agitating unit that is disposed more downstream than the most upstream mixing position in the hydrogen peroxide solution supply passage to thereby promote the heat generation accompanying the mixing of the sulfuric acid and the hydrogen peroxide solution and improve stripping performance of the resist stripping solution. The agitating unit is disposed more upstream than the most downstream mixing position and thus the resist stripping solution that exceeds a heat resistance temperature of the agitating unit can be made to flow through the flow passage from the most downstream mixing position to the nozzle. A substrate process (resist stripping process) using a high-temperature resist stripping solution can thus be performed without being restricted by the heat resistance temperature of the agitating unit.

The agitating unit maybe disposed between the most upstream mixing position and a downstream mixing position adjacent thereto in the hydrogen peroxide solution supply passage. With this arrangement, the agitating unit is disposed between the most upstream mixing position and the adjacent mixing position. This allows a high-temperature resist stripping solution exceeding the heat resistance temperature of the agitating unit to flow through at a downstream side of the adjacent mixing position. When the temperature of the sulfuric acid is low, a reaction time from the mixing of the sulfuric acid and the hydrogen peroxide solution to the discharge must be set long to secure time for temperature rise by the heat of reaction. The sulfuric acid supply passage connected to the most upstream mixing position is thus preferably selected in a case of using sulfuric acid of comparatively low temperature. Accordingly, the heat resistance temperature of the agitating unit should present no problem even if the agitating unit is disposed between the most upstream mixing position and the mixing position adjacent thereto. Also, even when sulfuric acid of low temperature is used by disposing the agitating unit at such a position, the heat of reaction due to mixing can be utilized adequately to form the resist stripping solution of high stripping performance that can then be discharged from the nozzle.

The sulfuric acid supply source may include a temperature raising unit that raises the temperature of the sulfuric acid supplied to the plurality of sulfuric acid supply passages. With this arrangement, the performance of the resist stripping solution can be increased further because the sulfuric acid can be raised in temperature. Also, the temperature of the sulfuric acid can be changed by changing a drive state of the temperature raising unit.

The sulfuric acid supply passage selecting unit may include on-off valves respectively interposed in the plurality of sulfuric acid supply passages. With this arrangement, the on-off valves are respectively interposed in the plurality of sulfuric acid supply passages and a sulfuric acid supply passage can be selected by opening/closing of the on-off valves. On-off valves with heat resistant specifications adaptable to high temperature fluids are commercially available, and the on-off valves of such heat resistant specifications may be disposed in the sulfuric acid supply passages. Each on-off valve preferably has an arrangement that enables automatic control by the control unit as in an air-driven type valve (air valve).

A preferred embodiment of the present invention provides a substrate processing method for supplying a resist stripping solution, formed by mixing sulfuric acid and hydrogen peroxide solution, to a surface of a substrate from a nozzle. The substrate processing method includes a reading step of reading a sulfuric acid temperature setting value into a control unit, a selecting step of selecting a single sulfuric acid supply passage from among a plurality of sulfuric acid supply passages by opening one of a plurality of on-off valves respectively interposed in the plurality of sulfuric acid supply passages, which corresponds to the sulfuric acid temperature setting value read in the reading step, a step of making the hydrogen peroxide solution flow through a hydrogen peroxide solution supply passage to which the plurality of sulfuric acid supply passages are respectively coupled at a plurality of mixing positions differing in flow passage length to the nozzle, a forming step of forming a resist stripping solution by causing the sulfuric acid passing through the selected sulfuric acid supply passage and the hydrogen peroxide solution flowing through the hydrogen peroxide solution supply passage to be joined and mixed at a mixing position, among the plurality of mixing positions, corresponding to the selected sulfuric acid supply passage, and a supplying step of supplying the resist stripping solution, formed in the forming step, to the surface of the substrate from the nozzle.

The aforementioned and other objects, features, and effects of the present invention shall be clarified by the following description of a preferred embodiment with reference to the accompanying drawings.

### BRIEF DESCRIPTION OF THE DRAWINGS

FIG. 1 is a schematic sectional view of an arrangement of a substrate processing apparatus according to a preferred embodiment of the present invention.

FIG. 2 is a block diagram for describing an electrical arrangement of the substrate processing apparatus.

FIG. 3 is a flowchart for describing a control operation of a control unit of the substrate processing apparatus.

FIG. 4A is a graph of a variation with time of temperature of an SPM prepared by mixing sulfuric acid of 80° C. and hydrogen peroxide solution of room temperature and a variation with time of oxidant concentration in the SPM.

FIG. 4B is a graph of a variation with time of temperature of an SPM prepared by mixing sulfuric acid of 180° C. and hydrogen peroxide solution of room temperature and a variation with time of oxidant concentration in the SPM.

FIG. 5 is a graph of resist stripping performance with respect to sulfuric acid temperature and mixing ratio.

### DETAILED DESCRIPTION OF THE PREFERRED EMBODIMENTS

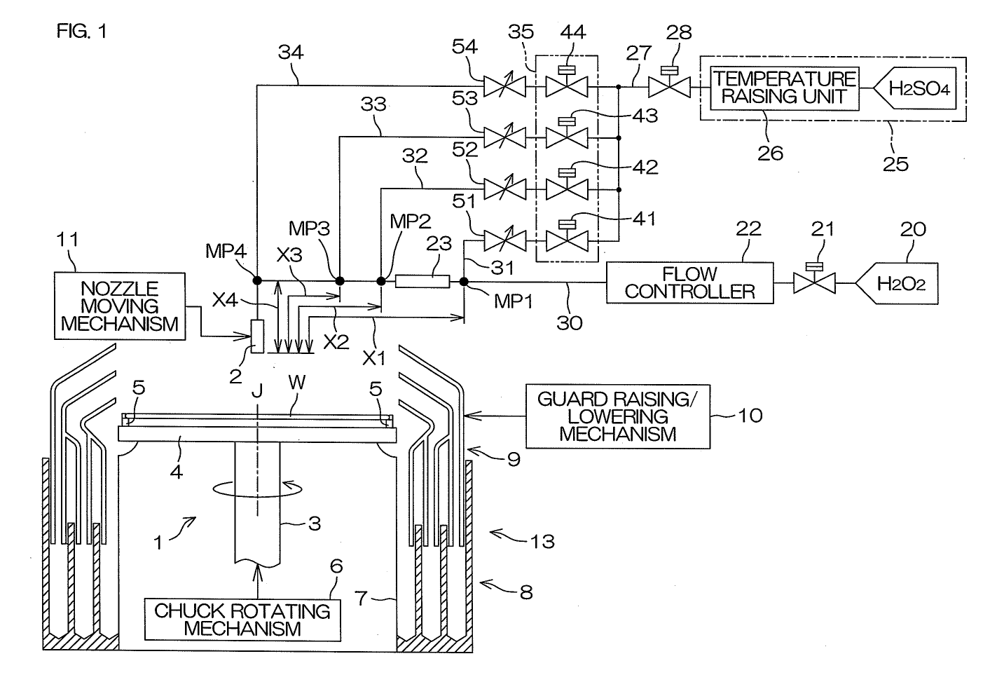

FIG. 1 is a schematic sectional view of an arrangement of a substrate processing apparatus according to a preferred embodiment of the present invention. The substrate processing apparatus is used for a resist removing (resist stripping) process for removing (stripping) a resist film formed on a surface of a substrate W, such as a semiconductor wafer, etc. The substrate processing apparatus is a one-by-one type substrate processing apparatus that processes substrates W one at a time. With the substrate processing apparatus, a sulfuric acid/hydrogen peroxide mixture (SPM), which is a mixed solution of sulfuric acid and a hydrogen peroxide solution, is used as a resist stripping solution.

The substrate processing apparatus includes a spin chuck 1 as a substrate holding mechanism that holds the substrate Win a substantially horizontal orientation and rotates it around a vertical axis, and a nozzle 2 that discharges the SPM toward the surface (upper surface) of the substrate W held by the spin chuck 1. Besides these, the substrate processing apparatus may also include a nozzle that supplies deionized water to the surface of the substrate W held by the spin chuck 1, a nozzle that supplies carbonated water to the surface of the substrate W, a two-fluid nozzle that sprays droplets of carbonated water, etc., onto the surface of the substrate W, an inert gas nozzle that supplies nitrogen gas or other inert gas to the surface of the substrate W, etc.

The spin chuck 1 includes a rotating shaft 3 disposed along a vertical direction, a disk-shaped spin base 4 fixed to an upper end of the rotating shaft 3, and a plurality of chuck pins 5 erected at a circumferential edge portion of the spin base 4. A rotational force from a chuck rotating mechanism 6 as a substrate rotating mechanism is transmitted to the rotating shaft 3. The chuck pins 5 are arranged to be switchable (open/closeable) between a clamping state of contacting a circumferential end surface of the substrate W and thereby clamping the substrate W and an open state of separating from the circumferential end surface of the substrate W and releasing the clamping of the substrate W. With this arrangement, when the chuck rotating mechanism 6 is driven in a state where the substrate W is clamped by the chuck pins 5, the substrate W rotates around the vertical axis J passing through its center. The chuck rotating mechanism 6 and the rotating shaft 3 are housed inside a cylindrical casing 7. Although in FIG. 1, a mechanical chuck that holds the substrate W mechanically is illustrated as an example, a substrate holding mechanism of another form, such as a vacuum chuck that holds a lower surface of the substrate W by suction, etc., may be used instead.

A processing liquid receiving portion 8 for collecting and then draining or recovering a processing liquid (a chemical solution or a rinse liquid) used for processing the substrate W is disposed in a fixed manner at a circumference of the casing 7. The processing liquid receiving portion 8, for example, has a plurality of annular grooves partitioned by a plurality of cylindrical partitioning plates that are formed coaxially. A splash guard 9 for receiving the processing liquid that splashes from the substrate W and guiding the liquid to the annular grooves of the processing liquid receiving portion 8 is disposed in a vertically movable manner above the processing liquid receiving portion 8. The splash guard 9 is moved vertically by a guard raising/lowering mechanism 10, and the processing liquid that splashes away from the substrate W due to centrifugal force is thereby received and made to flow down into any one of the annular grooves of the processing liquid receiving portion 8. The processing liquid receiving portion 8 and the splash guard 9 form a processing cup 13 that defines a processing space that houses the spin chuck 1.

The nozzle 2 has a form of a scan nozzle that is moved along the surface (upper surface) of the substrate W by a nozzle moving mechanism 11. The nozzle moving mechanism 11 may include a swinging arm extending in a horizontal direction, a rotating shaft coupled to a base end portion of the swinging arm and extending in the vertical direction, and a rotation drive mechanism that rotates the rotating shaft around the vertical axis. In this case, the nozzle 2 is fixed to a tip portion of the swinging arm. When the rotation drive mechanism is driven and the rotating shaft is rotated, the swinging arm swings within a horizontal plane and accordingly, the nozzle 2 moves horizontally above the substrate W. The nozzle moving mechanism 11 is arranged, for example, so that a liquid contact point of the processing liquid (resist stripping solution) discharged from the nozzle 2 forms a locus passing through a rotation center of the substrate W and a circumferential end edge of the substrate W. The liquid contact point of processing liquid (resist stripping solution) on the substrate W can thereby be scanned between the rotation center and the circumferential end edge of the substrate W.

The nozzle 2 is coupled to a hydrogen peroxide solution supply passage 30 that supplies a hydrogen peroxide solution from a hydrogen peroxide solution supply source 20 toward the nozzle 2. The hydrogen peroxide solution supply source 20 supplies the hydrogen peroxide solution of ordinary temperature (room temperature). A hydrogen peroxide solution valve 21 and a flow controller 22 are successively interposed in the hydrogen peroxide solution supply passage 30 from the hydrogen peroxide solution supply source 20 side. The hydrogen peroxide solution valve 21 is an on-off valve that opens and closes a flow passage of the hydrogen peroxide solution supply passage 30 and may be an air-driven valve or other valve enabled to be opened and closed by automatic control. The flow controller 22 can set a flow rate in accordance with a setting signal from an exterior and is arranged to pass a fluid at the set flow rate. The flow controller 22 is thus a flow regulator that enables flow regulation by automatic control.

A plurality of mixing positions MP1, MP2, MP3, and MP4 that differ in flow passage length to a tip (discharge port) of the nozzle 2 are set along the hydrogen peroxide solution supply passage 30. The first mixing position MP1 is positioned most upstream in relation to a direction of flow of the hydrogen peroxide solution in the hydrogen peroxide solution supply passage 30. The second mixing position MP2 is positioned adjacently across an interval at a downstream side with respect to the first mixing position MP1. The third mixing position MP3 is positioned adjacently across an interval at a downstream side with respect to the second mixing position MP2. The fourth mixing position MP4 is positioned adjacently across an interval at a downstream side with respect to the third mixing position MP3 and is the most downstream mixing position in the present preferred embodiment. Thus, with flow passage lengths X1, X2, X3, and X4 from the mixing positions MP1, MP2, MP3, and MP4 to the nozzle, the relationship, X1>X2>X3>X4, holds.

A finned agitation communication pipe 23 is interposed as an agitating unit between the first mixing position MP1 and the second mixing position MP2 adjacent at the downstream side in the hydrogen peroxide solution supply passage 30. The finned agitation communication pipe 23 has a plurality of agitating fins, each made of a rectangular plate-like body twisted by substantially 180 degrees about a liquid flow direction as an axis, disposed inside a pipe member with angles of rotation around a pipe central axis extending along the liquid flow direction being alternately offset by 90 degrees respectively. As the finned agitation communication pipe 23, for example, a product of the trade name “MX Series: Inline Mixer” made by Advance Electric Co., Inc. may be used. This inline mixer employs parts made by Noritake Company Limited.

A plurality of sulfuric acid supply passages 31, 32, 33, and 34 are connected to the hydrogen peroxide solution supply passage 30 respectively at the plurality of mixing positions MP1, MP2, MP3, and MP4. Sulfuric acid from a sulfuric acid supply source 25 is supplied to the plurality of sulfuric acid supply passages 31, 32, 33, and 34 from the supply source line 27. More specifically, the sulfuric acid supply passages 31, 32, 33, and 34 are branch passages branching from a supply source line 27. A sulfuric acid valve 28 is interposed in the supply source line 27 further upstream a point of branching into the sulfuric acid supply passages 31, 32, 33, and 34. The sulfuric acid valve 28 is an on-off valve that opens and closes a flow passage of the supply source line 27 and is an air-driven valve or other valve enabled to be opened and closed by automatic control. In the present preferred embodiment, the sulfuric acid supply source 25 includes a temperature raising unit 26 interposed in the supply source line 27. The temperature raising unit 26 is arranged to raise a temperature of the sulfuric acid from a supply source (for example, a tank storing the sulfuric acid) to a temperature higher than room temperature and then make the sulfuric acid flow to the downstream side. The sulfuric acid that has been raised to a temperature higher than room temperature is thus supplied to the plurality of sulfuric acid supply passages 31, 32, 33, and 34.

Respectively in the plurality of sulfuric acid supply passages 31, 32, 33, and 34, respective pairs of on-off valves 41, 42, 43, and 44 plus flow regulating valves 51, 52, 53, and 54 are interposed successively from the upstream side. The on-off valves 41, 42, 43, and 44 are valves that respectively open and close the sulfuric acid supply passages 31, 32, 33, and 34 and are air-driven valves or other valves enabled to be opened and closed by automatic control. The flow regulating valves 51, 52, 53, and 54 are needle valves or other valves with which opening degrees can be adjusted manually. Flow controllers are normally arranged to control flow rates of fluids at room temperature and thus cannot be disposed in the sulfuric acid supply passages 31, 32, 33, and 34 through which the sulfuric acid that is raised in temperature flow.

The plurality of on-off valves 41, 42, 43, and 44, respectively interposed in the plurality of sulfuric acid supply passages 31, 32, 33, and 34, make up a sulfuric acid supply passage selecting unit 35 that selects any one of the sulfuric acid supply passages 31, 32, 33, and 34 from among the plurality of sulfuric acid supply passages 31, 32, 33, and 34 to make the sulfuric acid from the supply source line 27 flow through the selected passage or passages. That is, when an on-off valve interposed in any one of the sulfuric acid supply passages is opened, the sulfuric acid from the supply source line 27 flows into the corresponding sulfuric acid supply passage. Although, typically, one sulfuric acid supply passage 31, 32, 33, or 34 is selected from among the plurality of sulfuric acid supply passages 31, 32, 33 and 34, two or more sulfuric acid supply passages may be selected by opening the on-off valves of two or more sulfuric acid supply passages at the same time.

By the on-off valve of any one of the sulfuric acid supply passages 31, 32, 33, and 34 being opened, the sulfuric acid flows into the hydrogen peroxide solution supply passage 30 at the corresponding mixing position MP1, MP2, MP3, or MP4. The sulfuric acid and the hydrogen peroxide solution are thereby mixed and a resist stripping solution (sulfuric acid/hydrogen peroxide mixture: SPM) made of the mixed solution is formed at the corresponding mixing position. The SPM reaches the nozzle 2 through the hydrogen peroxide solution supply passage 30 further downstream the mixing position and is discharged toward the substrate W from the nozzle 2. While the SPM flows through the hydrogen peroxide solution supply passage 30 over the flow passage length X1, X2, X3, or X4 until the nozzle 2 is reached from the mixing position, a mixing reaction of the sulfuric acid and the hydrogen peroxide solution in the SPM progresses and the SPM is raised in temperature by a heat of reaction that accompanies the reaction. The SPM of higher temperature than the temperature of the sulfuric acid supplied from the sulfuric acid supply source 25 is thereby discharged from the nozzle 2.

When the first sulfuric acid supply passage 31 corresponding to the first mixing position MP1 that is disposed most upstream is selected (that is, when the first on-off valve 41 is opened), the sulfuric acid and the hydrogen peroxide solution flow through the finned agitation communication pipe 23 after being mixed. The mixing is thereby promoted further and the heat of reaction due to mixing is generated more readily.

The plurality of mixing positions MP1, MP2, MP3, and MP4 are set to correspond to sulfuric acid of different temperatures. Specifically, four types of sulfuric acid temperatures are presumed and the first mixing position MP1 corresponds to the lowest sulfuric acid temperature (first sulfuric acid temperature; for example, 80° C.), the second mixing position MP2 corresponds to the second lowest sulfuric acid temperature (second sulfuric acid temperature; for example, 100° C.), the third mixing position MP3 corresponds to the third lowest sulfuric acid temperature (third sulfuric acid temperature; for example, 130° C.), and the fourth mixing position MP4 corresponds to the fourth lowest (highest in the present preferred embodiment) sulfuric acid temperature (fourth sulfuric acid temperature; for example, 180° C.). That is, the lower the sulfuric acid temperature, the longer the flow passage length from the mixing position to the tip of the nozzle 2. The flow passage length from each mixing position to the tip of the nozzle 2 is designed to be of an optimal value that is in accordance with the temperature of the sulfuric acid that joins with the hydrogen peroxide solution at the corresponding mixing position.

The opening degrees of the manually operated flow regulating valves 51, 52, 53, and 54 are adjusted in advance to correspond to the sulfuric acid temperatures presumed for the corresponding sulfuric acid supply passages 31, 32, 33, and 34. More specifically, the opening degrees of the flow regulating valves 51, 52, 53, and 54 are manually adjusted so that the sulfuric acid and the hydrogen peroxide solution are mixed at mixing ratios corresponding to the sulfuric acid temperatures and the SPM is discharged at required discharge flow rates from the nozzle 2.

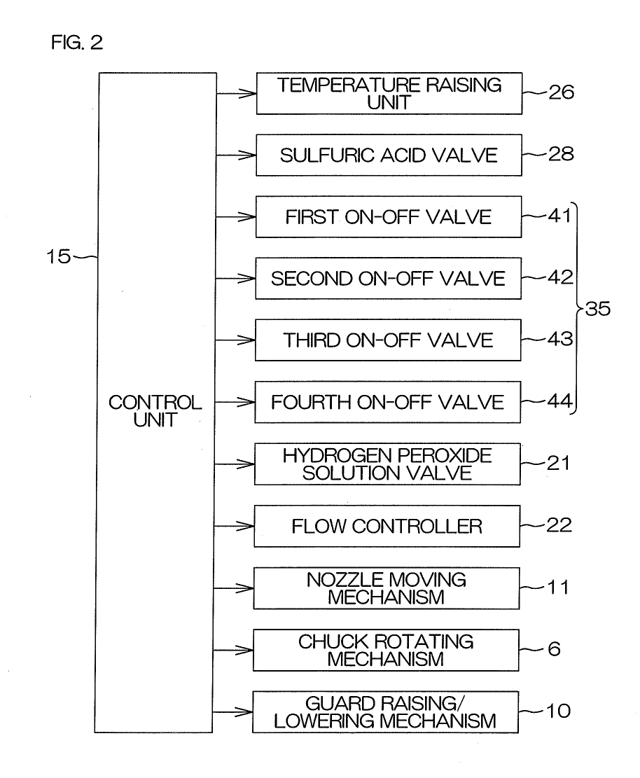

FIG. 2 is a block diagram for describing an electrical arrangement of the substrate processing apparatus. The substrate processing apparatus includes a control unit 15 for control of respective components of the apparatus. The control unit 15 has a basic arrangement as a computer and is programmed to control the chuck rotating mechanism 6, the guard raising/lowering mechanism 10, the nozzle moving mechanism 11, the hydrogen peroxide solution valve 21, the flow controller 22, the temperature raising unit 26, the sulfuric acid valve 28, the first to fourth on-off valves 41, 42, 43, and 44, etc.

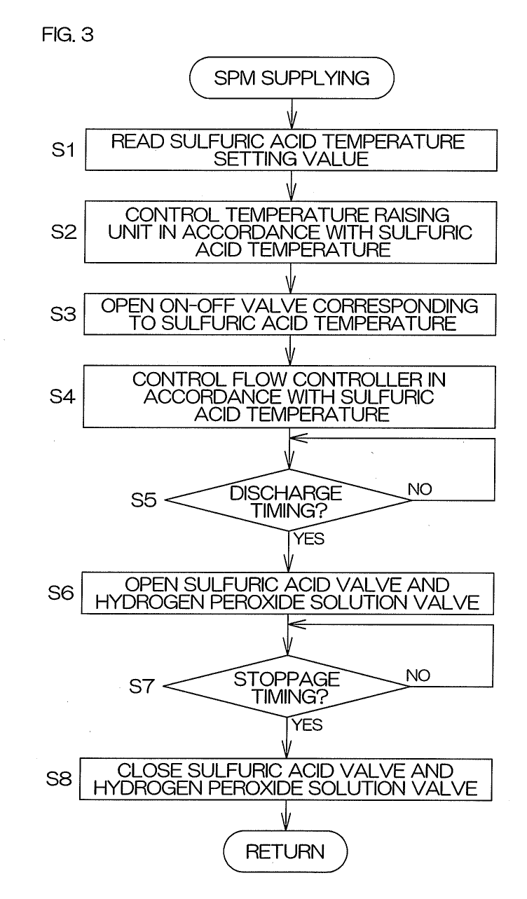

FIG. 3 is a flowchart for describing a control operation of the control unit 15 related to SPM (resist stripping solution) supplying. The control unit 15 reads a setting value of the temperature of the sulfuric acid to be mixed with the hydrogen peroxide solution (step S1). The sulfuric acid temperature setting value is a value that is input in advance by a user of the substrate processing apparatus. The sulfuric acid temperature setting value may be designated in a recipe that indicates substrate processing conditions. The control unit 15 controls the temperature raising unit 26 according to the sulfuric acid temperature setting value (step S2). The sulfuric acid that has been raised in temperature to the sulfuric acid temperature setting value is thereby supplied from the sulfuric acid supply source 25. The control unit 15 further opens any (preferably, any one) of the first to fourth on-off valves 41, 42, 43, and 44 in accordance with the sulfuric acid temperature setting value (step S3). Further, the control unit 15 controls the flow controller 22 in accordance with the sulfuric acid temperature setting value (step S4). Thereafter, at a timing at which the SPM is to be discharged onto the substrate W (step S5), the control unit 15 opens the sulfuric acid valve 28 and the hydrogen peroxide solution valve 21 (step S6), and thereafter, at a timing at which the discharge of the SPM onto the substrate W is to be stopped (step S7), closes the sulfuric acid valve 28 and the hydrogen peroxide solution valve 21 (step S8). Thereafter, the control returns to step S1.

Besides such control, the control unit 15 controls the chuck rotating mechanism 6 to control a rotation speed of the spin chuck 1, controls the guard raising/lowering mechanism 10 to control the position of the splash guard 9, and controls the nozzle moving mechanism 11 to control the position of the nozzle 2. The liquid contact point of the SPM on the substrate W can thereby be moved with respect to the surface (upper surface) of the substrate W in the rotating state while supplying the SPM from the nozzle 2. An entirety of the surface (upper surface) of the substrate W can thereby be scanned by the SPM liquid contact point and a uniform resist stripping process can be applied across the entire surface of the substrate W.

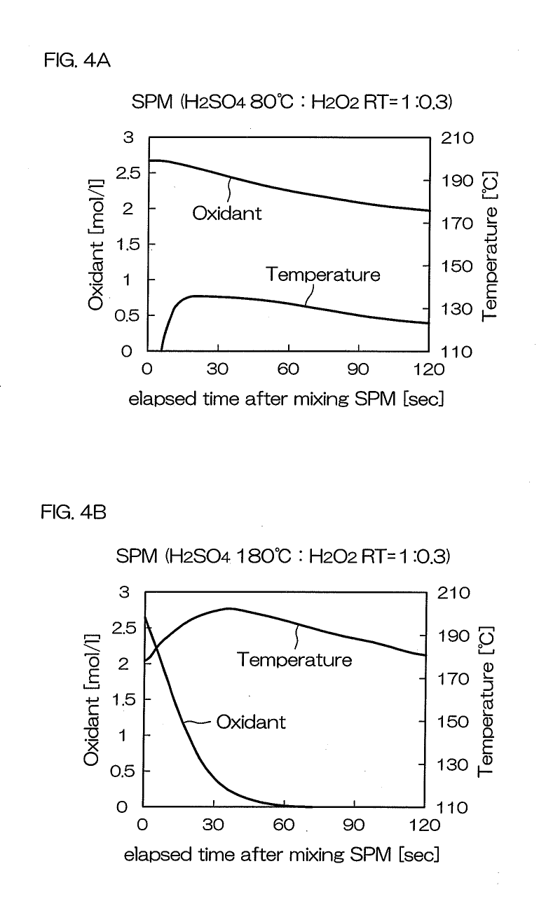

FIG. 4A shows (measurement results of) a variation with time of temperature of an SPM prepared by mixing sulfuric acid of 80° C. and hydrogen peroxide solution of room temperature (RT) at a mixing ratio of 1:0.3 and a variation with time of oxidant concentration in the SPM. Also, FIG. 4B shows (measurement results of) a variation with time of temperature of an SPM prepared by mixing sulfuric acid of 180° C. and hydrogen peroxide solution of room temperature (RT) at a mixing ratio of 1:0.3 and a variation with time of oxidant concentration in the SPM. In both figures, an abscissa indicates elapsed time after mixing of the SPM. A resist stripping performance of the SPM is higher the higher the temperature and higher the oxidant concentration. Thus, in the case where the sulfuric acid temperature is 80° C. (FIG. 4A), it is optimal for the SPM to arrive on the surface of the substrate at a point at which the elapsed time after mixing is approximately 20 seconds. Also, in the case where the sulfuric acid temperature is 180° C. (FIG. 4B), it is optimal for the SPM to arrive on the surface of the substrate at a point at which the elapsed time after mixing is approximately 5 seconds.

Thus, for example, the flow passage length X1 from the first mixing position MP1 to the tip of the nozzle 2 is set so that the time required for the SPM to reach the tip of the nozzle 2 from the first mixing position MP1 is approximately 20 seconds. The first sulfuric acid supply passage 31 can thereby be made to correspond to the sulfuric acid temperature of 80° C. Also, for example, the flow passage length X4 from the fourth mixing position MP4 to the tip of the nozzle 2 is set so that the time required for the SPM to reach the tip of the nozzle 2 from the fourth mixing position MP4 is approximately 5 seconds. The fourth sulfuric acid supply passage 34 can thereby be made to correspond to the sulfuric acid temperature of 180° C. The second mixing position MP2 and the third mixing position MP3 are set in likewise manner to correspond to other sulfuric acid temperatures.

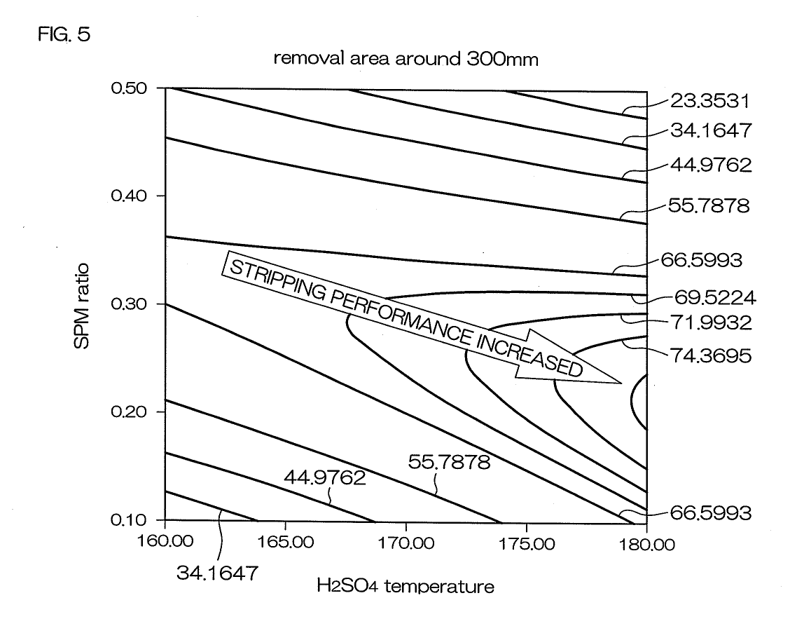

FIG. 5 shows the resist stripping performance with respect to the sulfuric acid temperature (H₂SO₄ temperature) and the mixing ratio (SPM ratio). The mixing ratio is expressed as a proportion of a volume of the hydrogen peroxide solution mixed with the sulfuric acid when the volume of the sulfuric acid is set to 1. In regard to the resist stripping performance (removal area around 300 mm), a resist film of fixed film thickness was formed across an entire surface of a circular wafer of 300 mm diameter and the performance was evaluated as a resist stripping area percentage (area of region from which a resist film was stripped/area of wafer surface; units: %) when the SPM was discharged onto a center of the wafer at a fixed flow rate for just a fixed duration. In a two-dimensional plane with an abscissa being the sulfuric acid temperature and an ordinate being the mixing ratio, an iso-stripping performance line is obtained by joining points at which equivalent resist stripping performance is obtained. The measurement results of FIG. 5 show that the resist stripping performance is dependent not only on the sulfuric acid temperature but also on the mixing ratio. It can thus be understood that the resist stripping performance can be maximized by mixing the sulfuric acid and the hydrogen peroxide solution at an appropriate mixing ratio that is in accordance with the sulfuric acid temperature.

The mixing ratio may be varied by setting the opening degrees of the flow regulating valves 51, 52, 53, and 54 interposed in the sulfuric acid supply passages 31, 32, 33, and 34 so that an equal flow rate is obtained for sulfuric acid of a plurality of temperatures and varying the flow rate of the hydrogen peroxide solution flowing through the hydrogen peroxide solution supply passage 30. However, in this case, the flow rate of the SPM discharged from the nozzle 2 varies in accordance with the mixing ratio. The same problem occurs in a case where the flow rate of the hydrogen peroxide solution flowing through the hydrogen peroxide supply passage 30 is fixed and the flow rates of the sulfuric acid flowing through the sulfuric acid supply passages 31, 32, 33, and 34 are differed. Thus, in order to make the SPM be discharged at a fixed flow rate from the nozzle 2 regardless of the mixing ratio, the flow rates of both the sulfuric acid and the hydrogen peroxide solution must be varied. Even in a case where the SPM discharge flow rate is not to be fixed (for example, in a case where the discharge flow rate is to be changed according to the sulfuric acid temperature), the flow rates of both the sulfuric acid and the hydrogen peroxide solution must be varied to obtain the desired discharge flow rate regardless of the mixing ratio.

Thus, in the present preferred embodiment, the flow regulating valves 51, 52, 53, and 54 interposed individually in the respective sulfuric acid supply passages 31, 32, 33, and 34 are enabled to individually set the respective flow rates of the sulfuric acid flowing through the sulfuric acid supply passages 31, 32, 33, and 34. Also, the flow controller 22 is interposed in the hydrogen peroxide solution supply passage 30 to enable control of the flow rate of the hydrogen peroxide solution. The mixing ratio that is in accordance with the sulfuric acid temperature and the desired discharge flow rate from the nozzle 2 can thus be achieved by selecting the sulfuric acid supply passage in accordance with the temperature of sulfuric acid before mixing and controlling the hydrogen peroxide solution flow rate by the flow controller 22.

As described above, with the present preferred embodiment, the plurality of sulfuric acid supply passages 31, 32, 33, and 34 are respectively connected to the plurality of mixing positions MP1, MP2, MP3, and MP4 along the hydrogen peroxide solution supply passage 30. Thus, at any one of the mixing positions, the sulfuric acid and the hydrogen peroxide solution are mixed and the resist stripping solution (SPM) made of the mixed solution is thereby formed. The SPM is raised in temperature by the exothermic reaction due to mixing inside the flow passage leading from the mixing position to the tip of the nozzle 2 and the SPM that has been raised in temperature is discharged toward the substrate W from the nozzle 2.

The control unit 15 controls the sulfuric acid supply passage selecting unit 35 (on-off valves 41, 42, 43, and 44) to select one or a plurality (preferably one) of the sulfuric acid supply passages among the plurality of sulfuric acid supply passages 31, 32, 33, and 34 and introduces the sulfuric acid from the sulfuric acid supply source 25 into each selected sulfuric acid supply passage. When a sulfuric acid supply passage is selected, the mixing position is selected at the same time. The SPM is thus discharged toward the substrate W from the nozzle 2 after a time, which is in accordance with a flow passage length from the selected mixing position to the nozzle 2, elapses after the mixing of the sulfuric acid and the hydrogen peroxide solution. During this time, the SPM rises in temperature due to heat generation by the mixing of the sulfuric acid and the hydrogen peroxide solution.

The flow regulating valves 51, 52, 53, and 54 are respectively interposed in the plurality of sulfuric acid supply passages 31, 32, 33, and 34 to enable the sulfuric acid flow rates to be adjusted individually. The sulfuric acid flow rate can thus be switched by switching the sulfuric acid supply passage and without using the flow controller. The opening degree of each of the flow regulating valves 51, 52, 53, and 54 can be adjusted in advance so that a flow rate that is in accordance with the temperature of the sulfuric acid introduced into the corresponding sulfuric acid supply passage is obtained. Thus, in a case where the sulfuric acid temperature is to be changed, switching to the sulfuric acid flow rate and mixing position that are in accordance with the sulfuric acid temperature after the change can be performed immediately by simply switching the sulfuric acid supply passage. That is, the mixing position and the sulfuric acid flow rate are set simultaneously and yet appropriately by selecting the sulfuric acid supply passage in accordance with the sulfuric acid temperature. A change of sulfuric acid temperature can thereby be accommodated readily. Moreover, the selection of the sulfuric acid supply passage can be performed by the on-off valves 41, 42, 43, and 44 that can be controlled automatically. The change of mixing position and sulfuric acid flow rate in accordance with the sulfuric acid temperature can thus be automated.

The flow rate of the hydrogen peroxide solution that is supplied at room temperature can be controlled automatically by the flow controller 22. The sulfuric acid and the hydrogen peroxide solution can thus be mixed at the mixing ratio that is in accordance with the sulfuric acid temperature and the SPM can be discharged onto the substrate W from the nozzle 2 at the desired discharge flow rate.

Also, with the present preferred embodiment, the finned agitation communication pipe 23 is interposed between the most upstream first mixing position MP1 and the adjacent second mixing position MP2. The SPM that is formed at the first mixing position MP1 into which the sulfuric acid of comparatively low temperature is introduced is thus agitated and mixed adequately by the finned agitation communication pipe 23. The heat generation accompanying the mixing of the sulfuric acid and the hydrogen peroxide solution can thereby be promoted to improve the stripping performance of the SPM. Moreover, at the downstream side of the finned agitation communication pipe 23, the SPM of a temperature exceeding a heat resistance temperature of the finned agitation communication pipe 23 can be made to flow through to thereby enable the SPM of high temperature exceeding the heat resistance temperature of the finned agitation communication pipe 23 to be supplied to the substrate W from the nozzle 2. The SPM of high resist stripping performance can thereby be supplied to the substrate W.

Although the preferred embodiment of the present invention has been described above, the present invention may be put into practice in other modes as well. For example, although the finned agitation communication pipe 23 is interposed between the first mixing position MP1 and the second mixing position MP2 in the preferred embodiment, the finned agitation communication pipe 23 may be omitted. Also, a finned agitation communication pipe may be interposed at one position or each of a plurality of positions among a position between the first mixing position MP1 and the second mixing position MP2, a position between the second mixing position MP2 and the third mixing position MP3, a position between the third mixing position MP3 and the fourth mixing position MP4, and a position between the fourth mixing position MP4 and the nozzle 2.

Also, although in the preferred embodiment, the sulfuric acid flow rates at the plurality of sulfuric acid supply passages 31, 32, 33, and 34 are set by means of the flow regulating valves 51, 52, 53, and 54, for example, a plurality of sulfuric acid supply passages 31, 32, 33, and 34 of flow rates that are in accordance with different sulfuric acid temperatures may be formed by individually setting flow passage cross-sectional areas of the sulfuric acid supply passages (for example, by individually selecting piping with different flow passage cross-sectional areas).

Although the preferred embodiment of the present invention has been described in detail, the embodiment is merely a specific example used to clarify the technical contents of the present invention, and the present invention should not be understood as being limited to this specific example, and the scope of the present invention is limited solely by the appended claims.

The present application corresponds to Japanese Patent Application No. 2011-154020 filed in the Japan Patent Office on Jul. 12, 2011, the entire disclosure of which is incorporated herein by reference.

What is claimed is:

1. A substrate processing apparatus for supplying a resist stripping solution, formed by mixing a sulfuric acid and a hydrogen peroxide solution, to a surface of a substrate, comprising:
a nozzle that discharges the resist stripping solution toward the substrate;
a hydrogen peroxide solution supply passage through which the hydrogen peroxide solution flows toward the nozzle;
a plurality of sulfuric acid supply passages respectively connected to a plurality of mixing positions along the hydrogen peroxide solution supply passage that differ in flow passage length to the nozzle; and
a sulfuric acid supply passage selecting unit that introduces the sulfuric acid from a sulfuric acid supply source to a sulfuric acid supply passage selected from among the plurality of sulfuric acid supply passages.

2. The substrate processing apparatus according to claim 1, wherein each of the plurality of sulfuric acid supply passages is arranged so that the sulfuric acid flows through toward the corresponding mixing position at an individually set flow rate.

3. The substrate processing apparatus according to claim 2, wherein the flow rates and the corresponding mixing positions of the plurality of sulfuric acid supply passages are set to correspond to respective sulfuric acids of different temperatures.

4. The substrate processing apparatus according to claim 3, further comprising: a control unit that controls the sulfuric acid supply passage selecting unit in accordance with a temperature of the sulfuric acid from the sulfuric acid supply source.

5. The substrate processing apparatus according to claim 1, further comprising: a plurality of flow regulating valves respectively interposed in the plurality of sulfuric acid supply passages.

6. The substrate processing apparatus according to claim 1, further comprising: a flow controller that controls a flow rate of the hydrogen peroxide solution flowing through the hydrogen peroxide solution supply passage.

7. The substrate processing apparatus according to claim 1, further comprising: an agitating unit disposed between a most downstream mixing position and a most upstream mixing position in the hydrogen peroxide solution supply passage and arranged to agitate a mixed solution of the sulfuric acid and the hydrogen peroxide solution.

8. The substrate processing apparatus according to claim 7, wherein the agitating unit is disposed between the most upstream mixing position and another mixing position adjacent at a downstream side of the most upstream mixing position in the hydrogen peroxide solution supply passage.

9. The substrate processing apparatus according to claim 1, wherein the sulfuric acid supply source includes a temperature raising unit that raises the temperature of the sulfuric acid supplied to the plurality of sulfuric acid supply passages.

10. The substrate processing apparatus according to claim 1, wherein the sulfuric acid supply passage selecting unit includes on-off valves respectively interposed in the plurality of sulfuric acid supply passages.

11. A substrate processing method for supplying a resist stripping solution, formed by mixing sulfuric acid and a hydrogen peroxide solution, to a surface of a substrate from a nozzle, the substrate processing method comprising:
a reading step of reading a sulfuric acid temperature setting value into a control unit;
a selecting step of selecting a single sulfuric acid supply passage from among a plurality of sulfuric acid supply passages by opening one of a plurality of on-off valves respectively interposed in the plurality of sulfuric acid supply passages, that corresponds to the sulfuric acid temperature setting value read in the reading step;
a step of making the hydrogen peroxide solution flow through a hydrogen peroxide solution supply passage to which the plurality of sulfuric acid supply passages are respectively coupled at a plurality of mixing positions differing in flow passage length to the nozzle;
a forming step of forming a resist stripping solution by causing the sulfuric acid passing through the selected sulfuric acid supply passage and the hydrogen peroxide solution flowing through the hydrogen peroxide solution supply passage to be joined and mixed at a mixing position, among the plurality of mixing positions, corresponding to the selected sulfuric acid supply passage; and
a supplying step of supplying the resist stripping solution, formed in the forming step, to the surface of the substrate from the nozzle.

12. The substrate processing method according to claim 11, wherein each of the plurality of sulfuric acid supply passages is arranged so that the sulfuric acid flows through toward the corresponding mixing position at an individually set flow rate.

13. The substrate processing method according to claim 12, wherein the flow rates and the corresponding mixing positions of the plurality of sulfuric acid supply passages are set to correspond to sulfuric acid of different temperatures.

14. The substrate processing method according to claim 11, wherein the sulfuric acid temperature setting value is designated in a recipe that indicates substrate processing conditions.

15. The substrate processing method according to claim 11, further comprising: a step of adjusting flow rates of sulfuric acid by a plurality of flow regulating valves respectively interposed in the plurality of sulfuric acid supply passages.

16. The substrate processing method according to claim 11, further comprising: a flow controlling step of controlling a flow rate of the hydrogen peroxide solution flowing through the hydrogen peroxide solution supply passage.

17. The substrate processing method according to claim 11, further comprising: an agitating step of agitating a mixed solution of sulfuric acid and hydrogen peroxide solution between a most downstream mixing position and a most upstream mixing position, of the plurality of mixing positions, in the hydrogen peroxide solution supply passage.

18. The substrate processing method according to claim 17, wherein the agitating step is performed between the most upstream mixing position and a downstream mixing position adjacent thereto of the plurality of mixing positions.

19. The substrate processing method according to claim 11, further comprising: a temperature raising step of raising the temperature of the sulfuric acid supplied to the plurality of sulfuric acid supply passages.
